(19) United States
(12) Patent Application Publication
(10) Pub. No.: US 2002/0109282 A1
(43) Pub. Date: Aug. 15, 2002

(54) Milling machine vise adjustable angle jaws

(76) Inventor: Loren Gary Peck, South Jordan, UT (US)

Correspondence Address: Loren Gary peck, 3298 West Iron Gate Road, South Jordan, UT, 84095, US

(21) Appl. No.: 09/737,913

(22) Filed: Dec. 13, 2000

(51) Int. Cl. B25B 1/24

(52) U.S. Cl. 269/258

(57) ABSTRACT

An angling vise attachable to a milling machine vise for angling the position of a work-piece in a secured fixed relation to the vise when being worked on. Angling vise includes jaw bases, which are removably attached to mill vise through a set of access openings on interior jaw base side designed to receive threaded screw members for securing to mill vise. Interior jaw bases being concaved to support a jaw with a congruent curvature and notched to secure a guide T-nut. Curved side of jaw is notched to receive guide T-nut, which allows jaw to be secured to jaw base, and to change its horizontal position. The interior side of jaws are machined flat, drilled and threaded to allow securing of adjustable face plates which become the vise clamping surface.

### CROSS-REFERENCE TO RELATED APPLICATIONS

Not applicable.

### BACKGROUND—FIELD OF INVENTION

This invention relates to vise jaws, specifically to an improved method of angling vise jaws.

### BACKGROUND—DESCRIPTION OF PRIOR ART

Heavy-duty machine vises used in milling provide specific functions for clamping and immobilizing work-pieces during machining operations. The fixed position of the jaws allow for the most part machining of work-pieces on a vertical or horizontal plane to the vice itself, limit the ability to machine pieces requiring angled milling. Such milling machines characterize this limitation as the SPI 6″ machine vise sold by SPI and a vise sold by Kurt Manufacturing Company under the trademark “Anglock.RTM”. These jaws consist of a vise bed, a stationary fixed jaw, and a slideable jaw. These vises are designed to provide tremendous clamping power and positive down force on the moveable jaw. This feature allows for adequate securing of a work-piece, but does not accommodate the angling of a work-piece. The inability to change the angle on milling machine vises requires different vise configuration set ups, or the development of angling tool pieces which are job specific. Either option can be time consuming and costly.

A number of devises have been invented for angling work-pieces. In milling machine vises for example, U.S. Pat. No. 4,706,949 to Robert L. Dossey and Truman J. Collins. This device utilizes various interchangeable jaw designs; one jaw design is specific for angling a work-piece on a vertical plane to the vise. Prior art suggest limitations of horizontal angling. Additionally, angle vises such as U.S. Pat. No. 4,789,146 to Andrew Kuei, have been designed to accommodate horizontal and vertical angling of work-pieces. The device of Kuei presents size limitations of work-pieces, and the ability for adequate securement.

Another deficiency of prior art devices is the fixed position of their jaws which eliminates their ability to adjust the angle of each independent jaw.

### DESCRIPTION OF THE DRAWINGS

FIG. 1 is a perspective view of a preferred form of machine vise unit.

FIG. 2 is a cross sectional view of angling vise mounted onto a machine vise unit as illustrated in FIG. 1.

FIG. 3 is a perspective exploded view of rear angling vise.

FIG. 4 is a plan view of back side of rear angling vise faceplate.

FIG. 5 is a top plan view of jaw.

FIG. 6 is a cutaway cross sectional view of rear angle vise mounted onto machine vise unit as illustrated in FIG. 1.

FIG. 7 is a side plan view of rear jaw base.

FIG. 8 is a side plan view of inverted jaw base.

### REFERENCE NUMERALS IN DRAWINGS

| | | | |
|---|---|---|---|
| 1. | 6 inch Kurt milling machine | 2. | Vise bed |
| 3. | Moveable jaw member | 4. | Fixed jaw member |
| 5. | Vise jaw | 6. | Mounting hole |
| 6a. | Mounting hole | 7. | Clamping surface |
| 7a. | Clamping surface | 8. | Vise jaw |
| 9. | Control handle | 10. | Inverted jaw base |
| 11. | Rear jaw base | 12. | Interchangeable jaw |
| 12a. | Interchangeable jaw | 14. | Faceplate |
| 15. | Faceplate | 16. | Mounting bolt holes |
| 16a. | Mounting bolt holes | 17. | Mounting bolt holes |
| 17a. | Mounting blot holes | 18. | ½″-13 × 1″ Allan cap |
| | | | screw |
| 18a. | ½ ″-13 × 1″ Allan cap screw | 19. | ½″-13 × 1″ Allan cap |
| | | | screw |
| 19a. | ½″-13 × 1″ Allan cap screw | 20. | Threaded mounting hole |
| 20a. | Threaded mounting hole | 21. | Threaded mounting hole |
| 21a. | Threaded mounting hole | 22. | T-nut bolt hole |
| 22a. | T-nut bolt hole | 23. | T-nut bolt hole |
| 23a. | T-nut bolt hole | 24. | Base jaw retainer step |
| 24a. | Base jaw retainer step | 25. | Base jaw retainer step |
| 25a. | Base jaw retainer step | 26. | Concave riding surface |
| 27. | Concave riding surface | 28. | Interchangeable T-nut |
| 28a. | Interchangeable T-nut | 29. | Jaw retainer step |
| 29a. | Jaw retainer step | 30. | Convex riding surface |
| 31. | T-nut slot | 31a. | T-nut slot |
| 32. | Jaw face | 33. | Jaw faceplate mounting |
| | | | hole |
| 33a. | Jaw faceplate mounting hole | 34. | Jaw mounting face |
| 35. | Clamping face | 35a. | Clamping face |
| 36. | Adjustable mounting slot | 36a. | Adjustable mounting slot |
| 37. | T-nut clearance pocket | 37a. | T-nut clearance pocket |
| 38. | T-nut cap screws | 38a. | T-nut cap screws |
| 39. | Faceplate mounting screws | 39a. | Faceplate mounting screws |

### DESCRIPTION OF THE INVENTION

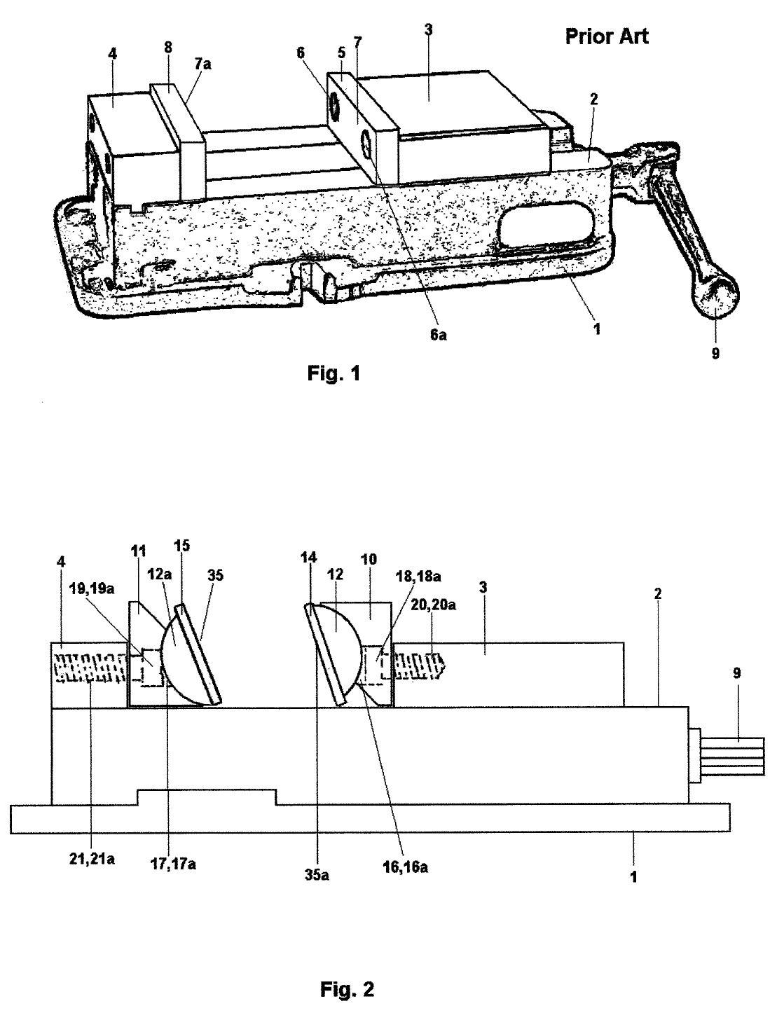

Referring to FIG. 1, illustrating a 6 inch milling machine vise manufactured by Kurt Manufacturing Company 1 consisting of a vise bed 2 a moveable jaw member 3, which is adjustable by means of a screw thread, not illustrated in FIG. 1, attached to control handle 9. Vise jaw 5 is removably attached to moveable jaw member 3 by mounting hole 6 and mounting hole 6a secured by means of ½″×13×1″ Allan head cap screws, not illustrated in FIG. 1. Vise jaw 8 is removably attached to fixed jaw member 4. Vise jaws 5 and 8 are in fixed relation to one another with interior surfaces 7 and 7a comprising the clamping surface. FIG. 2 illustrates attachable angling vise invention in relation to securement of angling vise invention onto a preferred form of machine vise unit as illustrated in FIG. 1. Vise jaw 5 is removed and replaced with removably attached inverted jaw base 10. Vise jaw 8 is removed and replaced with removably attached rear jaw base 11. In one embodiment, inverted jaw base 10 and rear jaw base 11 are made of AISI A2 tool grade steel. In a second embodiment, inverted jaw base 10 and rear jaw base 11 are made of cold rolled steel. In a third embodiment, inverted jaw base 10 and rear jaw base 11 are made of casted steel. In a fourth embodiment, inverted jaw base 10 and rear jaw base 11 are made of stainless steel. Inverted jaw base 10 is secured to moveable jaw member 3 by means of mounting bolt holes 16 and 16a, drilled in fixed relation to manufacturers threaded mounting holes 20 and 20a in moveable jaw member 3. Inverted jaw base 10 is removably attached to moveable jaw member 3 by means of ½″×13×1″ Allan head cap screws 18 and 18a. Rear jaw base 11 is secured to fixed jaw member 4 by means of mounting bolt holes 17 and 17a, drilled in fixed relation to manufacturers threaded mounting holes 21 and 21a in fixed jaw member 4. Rear jaw base 11 is removably attached to fixed jaw member 4 by means of ½″×13×1″ Allan head cap screws 19 and 19a.

Interior side of inverted jaw base 10 and rear jaw base 11 are concaved to receive, support, and allow angling of 0° to 45° of interchangeable jaw 12 and interchangeable jaw 12a. In one embodiment, interchangeable jaw 12 and interchangeable jaw 12a are made of AISI A2 tool grade steel. In a second embodiment, interchangeable jaw 12 and interchangeable jaw 12a are made of cold rolled steel. In a third embodiment, interchangeable jaw 12 and interchangeable jaw 12a are made of casted steel. In a fourth embodiment, interchangeable jaw 12 and interchangeable jaw 12a are made of stainless steel. Interchangeable jaw 12 and interchangeable jaw 12a are secured to inverted jaw base 10 and rear jaw base 11 by means of removably interchangeable attached T-nuts, not illustrated in FIG. 2

Faceplate 14 is secured to interchangeable jaw 12 or interchangeable jaw 12a and mounted to inverted jaw base 10. Faceplate 15 is secured to interchangeable jaw 12 or interchangeable jaw 12a and mounted to rear jaw base 11. In one embodiment, faceplate 14 and 15 is made of AISI A2 tool grade steel. In a second embodiment, faceplate 14 and 15 is made of cold rolled steel. In a third embodiment, faceplate 14 and 15 is made of casted steel. In a fourth embodiment, faceplate 14 and 15 is made of stainless steel. In a fifth embodiment, faceplate 14 and 15 is made of plastic. In a sixth embodiment, faceplate 14 and 15 is made of rubber. In a seventh embodiment, faceplate 14 and 15 is made of aluminum. Interior side of faceplate 14 comprising clamping face 35a, interior side of faceplate 15 comprising clamping face 35.

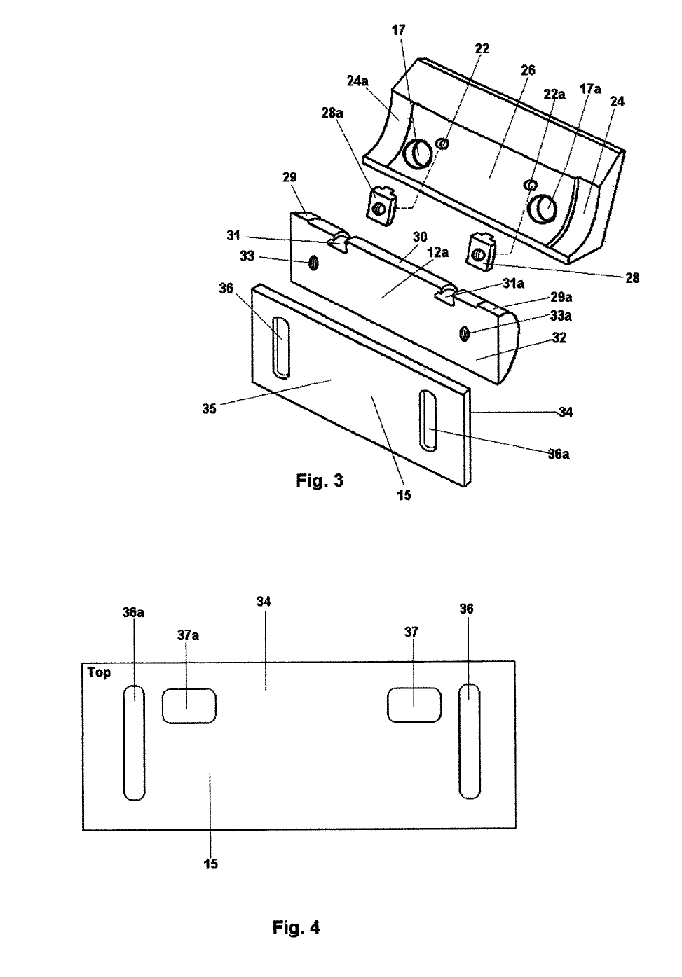

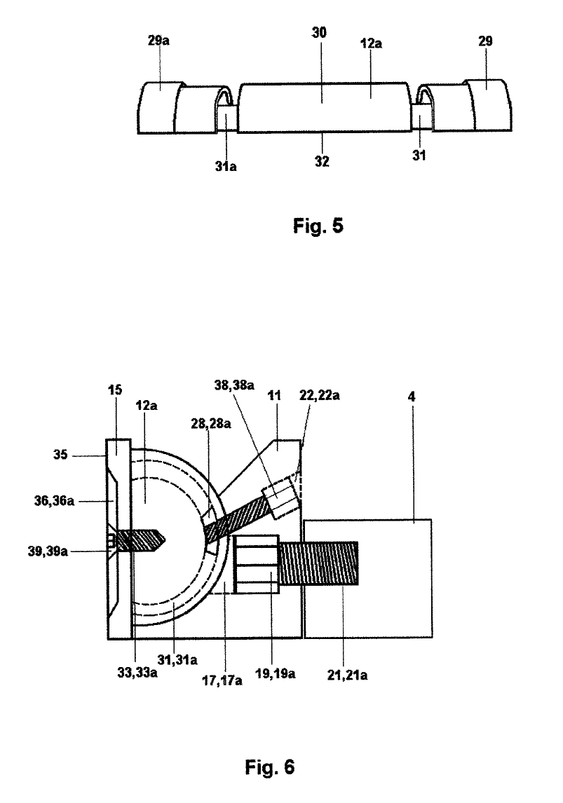

FIGS. 3-6 illustrate specific and interchangeable components in relation to rear jaw base 11. Whereas rear jaw base 11 is comprised of mounting bolt hole 17 and mounting bolt hole 17a, and T-nut bolt hole 22 and T-nut bolt hole 22a, and base retainer step 24 and base retainer step 24a and concave riding surface 26, and threaded interchangeable T-nut 28 and threaded interchangeable T-nut 28a. Threaded interchangeable T-nut 28 and threaded interchangeable T-nut 28a are removably attached to concave riding surface 26 by means of T-nut mounting screw 38 and T-nut mounting screw 38a. In one embodiment, T-nut mounting screw 38 and T-nut mounting screw 38a are threaded ¼″×20×⅞″ Allan head cap screws. In a preferred embodiment, interchangeable T-nut 28 and interchangeable T-nut 28a are made of AISI A2 tool grade steel.

Interchangeable jaw 12a consisting of jaw retainer step 29, and jaw retainer step 29a, convex riding surface 30 and T-nut slot 31 and T-nut slot 31a, and jaw face 32 and faceplate mounting hole 33 and faceplate mounting hole 33a. Face plate 15 consisting of jaw mounting face 34, clamping face 35, adjustable mounting slot 36 and adjustable mounting slot 36a.

Face plate 15 is removably attached to jaw face 32 of interchangeable jaw 12a by means of faceplate mounting screw 39 and faceplate mounting screw 39a. In one embodiment, faceplate mounting screw 39 and faceplate mounting screw 39a are #10-24×½″ Allan head flat screws. Faceplate 15 is specific to rear jaw base 11 consisting of T-nut clearance pocket 37 and T-nut clearance pocket 37a notched in jaw mounting face 34 to allow interchangeable jaw 12a as illustrated in FIG. 3, to achieve a 45° angle.

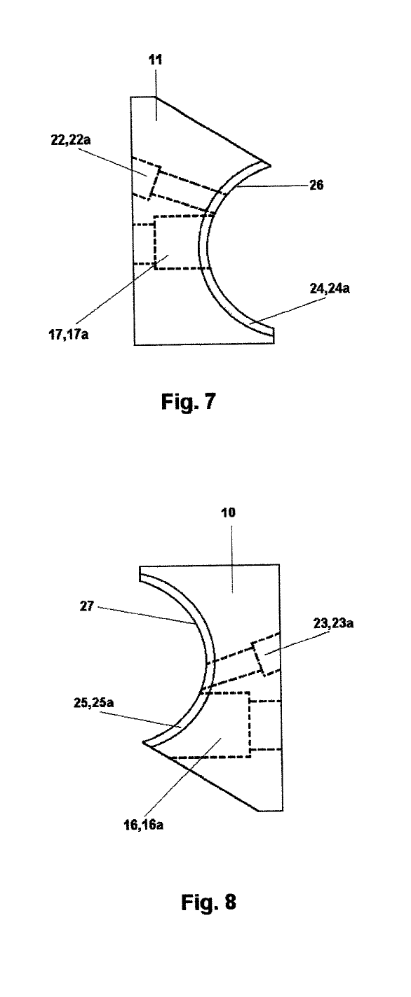

FIG. 7 illustrates rear jaw base 11 with fixed relationship of mounting bolt holes 17 and 17a, and fixed relationship of T-nut bolt holes 22 and 22a.

FIG. 8 illustrates inverted jaw base 10 with fixed relationship of mounting bolt holes 16 and 16a and fixed relationship of T-nut bolt holes 23 and 23a, and fixed relationship of base jaw retainer step 25, and base jaw retainer step 25a, and fixed relationship of concave riding surface 27.

While the invention has been particularly shown and described, it will be understood by those skilled in the relevant art that various changes in form and detail may be made without departing from the spirit and scope of this invention.

1. A devise for angling a work-piece in a milling machine vise, said devise comprising:
a. A first and second jaw base removably attachable to a milling machine vise, said jaws rounded in facing relation to one another. In relation to first jaw base, said jaw bases are rectangular with concaved facings for mounting jaws and face plates;
b. Mounting means between said jaw bases to milling machine vise, said facings of jaw bases being stepped and notched for mounting of first and second jaws; said mounting means of jaw bases and jaws defined by vertical T-nut inserts in jaw base facings and vertical T-channels in arced facing of jaws, and
c. A flat machined surface on opposite side of jaws with means for attachably mounting jaw face plates on jaws, one and two, said adjustable face plate facing relation to one another define clamping area.

2. An angle device as claimed in claim 1 wherein a work piece angle can be adjusted horizontally 0° to 45° degrees.

3. An angle device as claimed in claim 1 wherein said clamping area plates can be horizontally angled from 0° to 45° degrees independent from each other.

4. An angle device as claimed in claim 1 wherein a plurality of interchangeable jaw faceplates can be attached to first and second jaws.
